(19) United States
(12) Patent Application Publication
(10) Pub. No.: US 2015/0211583 A1
(43) Pub. Date: Jul. 30, 2015

(54) PRE-MOUNTED MODULE OF A TRANSMISSION ASSEMBLY FOR A HYBRID VEHICLE AND METHOD FOR MOUNTING A TRANSMISSION ASSEMBLY

(71) Applicant: VALEO EQUIPEMENTS ELECTRIQUES MOTEUR, Creteil Cedex (FR)

(72) Inventors: Svetislav Jugovic, Athis-Mons (FR); Khadija El Baraka, Serris (FR); Gilles Lebas, Villiers Bretonneux (FR); Fabien Lebeau, Harly (FR); Christophe Mollier, Amiens (FR)

(73) Assignee: VALEO EQUIPEMENTS ELECTRIQUES MOTEUR, Creteil Cedex (FR)

(21) Appl. No.: 14/424,905

(22) PCT Filed: Sep. 30, 2013
(86) PCT No.: PCT/FR2013/052178

§ 371 Date: Feb. 27, 2015

(30) Foreign Application Priority Data
Sep. 25, 2012 (FR) 1258978
May 22, 2013 (FR) 1354579

(51) Int. Cl. F16D 13/58; F16D 21/08; H02K 7/108; F16D 13/38

(52) U.S. Cl. CPC F16D 13/58; F16D 13/38; F16D 21/08; H02K 7/108; Y10S 903/914

(57) ABSTRACT

A preassembled module for a motor vehicle transmission to be arranged between an engine block and gearbox is disclosed. A support element has elements for fixing to the engine block and/or the gearbox. A clutch bearing is mounted on the support element for actuating a clutch. An intermediate rotatable shaft has a splined end to collaborate with a hub of a friction disk of the clutch, and the intermediate shaft collaborates with the support element via a bearing supporting and guiding the rotation of the intermediate shaft with respect to the support element. An electric machine has an external stator supported by the support element and a rotor having a central opening through which the intermediate shaft passes. The rotor rotates as one with the intermediate shaft. A reaction plate of a clutch, on the gearbox side, which rotates as one with the intermediate shaft.

### TECHNICAL FIELD

The invention relates to the field of transmissions for motor vehicles. It relates notably to a preassembled module for a transmission assembly intended to be positioned between an internal combustion engine and a gearbox of a motor vehicle.

It relates in particular to a transmission assembly for a motor vehicle of the hybrid type in which an electric machine is arranged, in the drivetrain, between the engine and the gearbox.

### TECHNOLOGICAL BACKGROUND

Transmission assemblies for hybrid motor vehicles, comprising two clutches and an electric machine which are arranged between the internal combustion engine of the vehicle and its gearbox, are known. Such an assembly is, for example, described in document FR 2 830 589. Each of the clutches comprises a friction disc, a clutch bearing, a reaction plate and a clutch mechanism, comprising a pressure plate mounted with the ability to move axially with respect to the said reaction plate between an engaged position in which the friction disc is trapped between the said pressure plate and reaction plate and a disengaged position. The two clutches are arranged one on each side of the electric machine. The mechanism of a first clutch, arranged on the engine side, is configured to be associated with the crankshaft of the internal combustion engine. The friction disc of the first clutch is mounted to rotate as one with an intermediate shaft which is fixed to a support hub for supporting the rotor of the electric machine. The mechanism and the reaction plate of the second clutch, arranged on the gearbox side, are mounted to rotate as one with the said rotor support hub and the friction disc of the said second clutch is intended to collaborate with an input shaft of a gearbox.

The clutch on the engine side therefore allows the crankshaft of the internal combustion engine to be rotationally coupled to the rotor of the electric machine, and the clutch on the gearbox side allows the rotor to be coupled to the input shaft of the gearbox. In this way, the internal combustion engine can be switched off at each stop and restarted using the electric machine. The electric machine may also constitute an electric brake or supply additional energy to the combustion engine to assist it or prevent it from stalling. When the engine is running, the electric machine acts as an alternator.

Mounting such a transmission assembly is complex notably in so far as the assembling of the elements of the transmission assembly entails numerous operations which are performed on the assembly lines on which the gearbox is assembled with the engine block.

### SUMMARY

One idea underlying the invention is that of making it easier to mount a transmission assembly that combines two clutches and an electric machine.

In order to achieve this, according to one embodiment, the invention proposes a preassembled module for a motor vehicle transmission assembly intended to be arranged between an engine block and gearbox, comprising:

a support element provided with fixing elements for fixing to the engine block and/or to the gearbox;

a clutch bearing, mounted on the said support element, intended to actuate a clutch on the engine side;

an intermediate shaft with the ability to rotate, comprising a splined end intended to collaborate with a hub of a friction disk of the said clutch, on the engine side, the said intermediate shaft collaborating with the support element via a bearing supporting and guiding the rotation of the intermediate shaft with respect to the support element;

an electric machine comprising an external stator supported by the support element and a rotor having a central opening through which the intermediate shaft passes, the said rotor being mounted to rotate as one with the said intermediate shaft; and

a reaction plate of a clutch, on the gearbox side, which rotates as one with the said intermediate shaft.

Thus, mounting the transmission assembly becomes easier because some of the elements of the transmission assembly come in the form of a preassembled module that can be handled and transported.

According to some embodiments, such a preassembled module may comprise one or more of the following features:

the intermediate shaft collaborates with the support element via a rolling bearing, the support element comprising a cylindrical bore for housing the said rolling bearing which is limited, on the engine side, by a radial surface against which the rolling bearing can press axially, and the intermediate shaft comprising, on the gearbox side, a shoulder defining a radial surface against which the rolling bearing can press axially.

the rolling bearing comprises an external ring coupled axially to the support element and an internal ring coupled axially to the intermediate shaft.

the internal ring is coupled axially to the intermediate shaft by force-fitting and/or by immobilizing members.

the external ring is coupled axially to the support element by force-fitting and/or by immobilizing members.

the rotor is mounted to rotate as one with the intermediate shaft by means of a sheet metal support hub, the said hub comprising an axial skirt for supporting the rotor and an annular radial web bearing the reaction plate of the clutch on the gearbox side.

the intermediate shaft comprises a collar and the support hub that supports the rotor comprises an internal flange, extending radially towards the inside of the axial skirt, fixed to the said collar of the intermediate shaft.

the module comprises a clutch on the gearbox side, the said clutch comprising, in addition to the reaction plate that rotates as one with the intermediate shaft, a friction disk comprising a splined hub intended to collaborate with complementary splines of an input shaft of the gearbox and a pressure plate, which rotates as one with the reaction plate and is mounted with the ability to move axially with respect to the said reaction plate between an engaged position in which the friction disk is gripped between the said pressure and reaction plates and a disengaged position.

the support element is provided with through-orifices for the passage of fixing members.

the stator is fixed to the support element by shrink-fitting or force-fitting.

According to one embodiment, the invention also relates to a method for mounting a transmission assembly for a motor vehicle between an engine block and a gearbox, the said method comprising:

a step of mounting a clutch, on the engine side, on the engine block;

a step of assembling an aforementioned preassembled module;

a step of mounting the preassembled module on the gearbox casing or on the engine block; and

a step of assembling the gearbox and the engine block, the gearbox and the engine block being fixed to one another via the preassembled module.

Such a method is particularly simple to implement because a large proportion of the elements of the transmission assembly is delivered to the assembly lines on which the transmission and the engine block are assembled in the form of a preassembled module. Furthermore, such a method can be implemented on assembly lines requiring very few modifications to the assembly process.

According to some embodiments, such a method may comprise one or more of the following features:

the support element is provided with fixing through-orifices for the passage of fixing screws, the preassembled module being mounted on the casing of the gearbox before the gearbox and the engine block are assembled, the step of mounting the preassembled module on the casing of the gearbox involving the introduction of screws into a first group of fixing orifices so as to fix the preassembled module to the casing of the gearbox and the step of assembling the gearbox and the engine block involving the introduction of screws into a second group of fixing orifices in order to fix the preassembled module to the engine block.

the support element is provided with fixing through-orifices for the passage of fixing screws and the preassembled module is mounted on the engine block before the gearbox and the engine block are assembled, the step of mounting the preassembled module on the casing of the gearbox involving the introduction of screws into a first group of fixing orifices so as to fix the preassembled module to the engine block, and the step of assembling the gearbox and the engine block involving the introduction of screws into a second group of fixing orifices in order to fix the preassembled module to the casing of the gearbox.

the support element is provided with fixing through-orifices for the passage of fixing members and in which the fixing members are studs with two threaded ends.

### BRIEF DESCRIPTION OF THE FIGURES

The invention will be better understood, and other objects, details, features and advantages thereof will become more clearly apparent during the course of the following description of a number of particular embodiments of the invention which are given solely by way of nonlimiting illustration and with reference to the attached drawings.

FIG. 1 is a view in axial section of a transmission assembly comprising two clutches and an electric machine and intended to be arranged between an internal combustion engine and a gearbox.

FIG. 2 is a view, in axial section, of a hydraulically operated clutch bearing for actuating the clutch, on the engine side.

FIG. 3 is a partial perspective view, on the engine side, of an electric machine stator support element having a housing for accepting a clutch bearing.

FIG. 4 is a perspective view of a clutch bearing.

FIG. 5 is a view in axial section of the housing of the stator support element of FIG. 3.

FIGS. 6 to 8 are views in axial section, showing the successive steps in mounting the clutch bearing in the stator support element of FIG. 3.

FIG. 9 is a perspective view depicting the locking tabs in a radially inwardly flexed position in which the protuberances are, in the released position, and extend outside of their respective locking cavity.

FIG. 10 is a view in section of a clutch bearing and of a stator support element according to another embodiment.

FIG. 11 is a perspective view illustrating a clutch fixed to the engine block and a pre-assembled module which are able to form a transmission assembly according to FIG. 1.

FIG. 12 is an engine-side perspective view of the transmission assembly of FIG. 1.

FIGS. 13, 14 and 15 are views in axial section of a transmission assembly comprising two clutches and an electric machine according to a second, a third and a fourth embodiment.

FIG. 16 is a partial view in axial section of a transmission assembly comprising two clutches and an electric machine and equipped with a dust flange arranged between the electric machine and the clutch, on the gearbox side.

FIG. 17 is an exploded perspective view of the stator and of the dust flange of the electric machine of FIG. 16.

FIG. 18 is a perspective view of the stator and of the flange of FIG. 17, when they have been assembled.

FIG. 19 is a perspective view illustrating a stator of an electric machine according to one embodiment.

FIG. 20 is a perspective view of one of the coils of FIG. 19.

FIG. 21 is a partial face-on view of a rotor of an electric machine according to one embodiment.

### DETAILED DESCRIPTION OF EMBODIMENTS

In the description and in the claims the terms “external”, “internal”, “front”, “rear” and the orientations “axial” and “radial” will be used to designate, according to the definitions given in the description, elements of the transmission assembly.

By convention, the “radial” orientation is directed orthogonally to the axis X of rotation of the assembly determining the “axial” orientation. The “circumferential” or “tangential” orientation is directed orthogonally to the axis X of the assembly and orthogonally to the radial direction.

The terms “external” and “internal” are used to define the relative position of one element with respect to another in the radial direction, with reference to the axis X, an element close to the axis is thus qualified as internal as opposed to an external element which is situated radially at the periphery. The terms “front” and “rear” are used to define the relative position of one element with respect to another in the axial direction, an element close to the combustion engine being denoted as front as opposed to an element close to the gearbox denoted as rear.

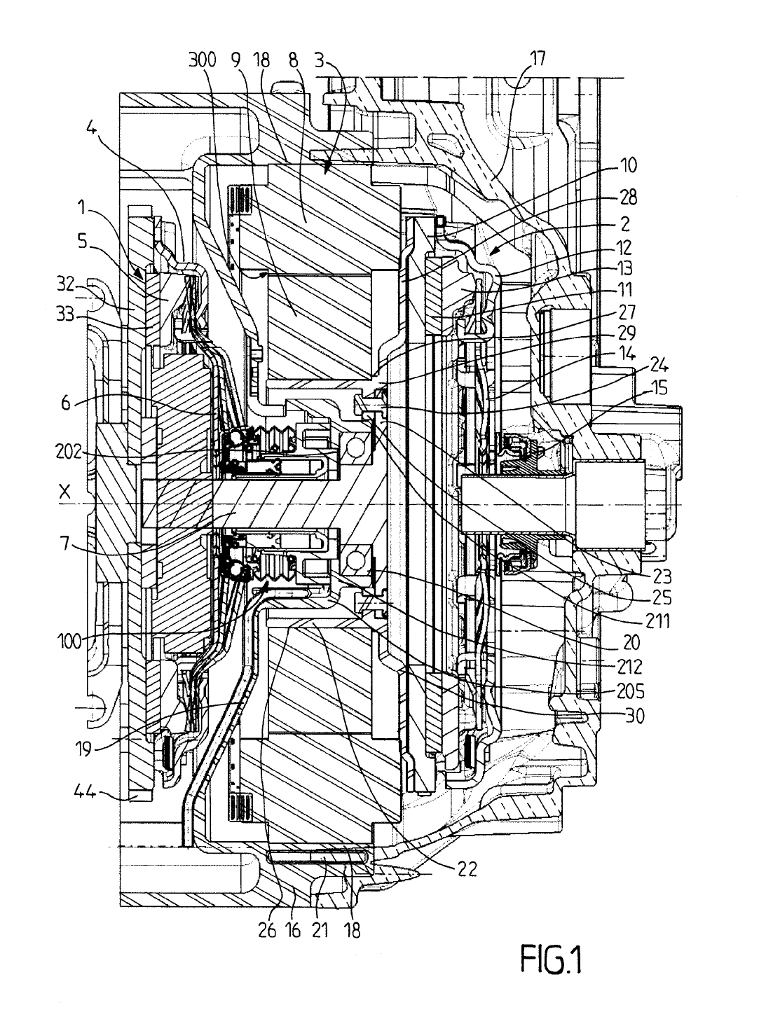

Reference is made to FIG. 1 which shows a transmission assembly intended to be arranged between a combustion engine and a gearbox, which comprises a clutch 1 on the engine side, a clutch 2 on the gearbox side, and an electric machine 3 comprising a stator 8 and a rotor 9.

The clutch 1 on the engine side allows the crankshaft of the combustion engine, not depicted, to be coupled to or uncoupled from the rotor 9 of the electric machine 2. The clutch 2 on the gearbox side allows the rotor 9 of the electric machine 3 to be coupled to or uncoupled from an input shaft of the gearbox, not depicted. The assembly is therefore able to transmit torque between the combustion engine crankshaft and the input shaft of the gearbox.

The electric machine 3 is a reversible rotary electric machine of the alternator/starter type or of the motor/generator type. In starter mode, the clutch 1 on the engine side is engaged and the electric machine 3 allows the starting of the combustion engine. In alternator mode, the electric machine 3 allows a battery of the vehicle to be recharged and/or allows energy consuming equipment to be powered while the combustion engine is running. It is also configured to recuperate energy when the vehicle is braking. The electric machine 3 may notably be configured to stop the combustion engine, for example at red lights or in traffic jams, and then restart it (known as the “stop and go” function). In one embodiment, it is able to supply additional power to prevent the engine from stalling (this is known as the “boost” function). Moreover, the electric machine 3 is able to drive the vehicle at least over a short distance, the clutch 1 on the engine side then being disengaged and the combustion engine switched off

The clutch 1 on the engine side comprises a reaction plate 32 borne by an engine flywheel intended to be mounted on the crankshaft, a friction disc 33 and a clutch mechanism comprising a cover 4 fixed to the reaction plate 32, a pressure plate 5 and a diaphragm 6. The friction disc 33 has a splined hub collaborating with splines formed on an intermediate shaft 7.

The pressure plate 5 is made to rotate as one with the cover 4 by elastic tangential fingers, not illustrated, that have an axial action allowing the pressure plate 5 to move axially with respect to the reaction plate 32. In this way, the pressure plate 5 is able to move, with respect to the reaction plate 32, between an engaged position in which the friction disc is trapped between the said pressure plate 5 and reaction plate 32, and a disengaged position.

In the engaged position, the clutch 1 is engaged and torque is transmitted from the crankshaft to the intermediate shaft 7 via the first clutch 1. The diaphragm 6 is in contact firstly, at its internal periphery, with a clutch bearing 100 and secondly with a boss on the pressure plate 5. The diaphragm 6 urges the pressure plate 5 towards the reaction plate 32.

To disengage the clutch 1, the clutch bearing 100 moves the internal periphery of the diaphragm axially forwards so as to cause the diaphragm 6 to tilt. Thus, the load applied by the diaphragm 6 to the pressure plate 5 decreases so that the pressure plate 5 is returned rearwards under the action of the elastic tangential fingers.

The clutch 2 on the gearbox side comprises a reaction plate 10 that rotates as one with the intermediate shaft 7, a friction disc 11 and a clutch mechanism comprising a cover 12, fixed to the reaction plate 10, a pressure plate 13 able to move axially with respect to the reaction plate 10 between an engaged position and a disengaged position, and a diaphragm 14. The clutch 2 on the gearbox side is also equipped with elastic tangential fingers connecting the pressure plate 13 for the purposes of rotation to the cover 12.

The friction disc 11 is equipped with a splined hub intended to collaborate with splines formed at the end of the input shaft of the gearbox, not depicted. A clutch bearing 15 allows the diaphragm 14 to be made to tilt in order to disengage the clutch 2.

In order to dissipate the heat energy generated locally by the friction of the friction linings of the clutch discs 3, 11 on the pressure plates 5, 13 and reaction plates 32, 10 of the clutches 1, 2, the said pressure plates 5, 13 and reaction plates 32, 10 are typically made of cast iron.

The reversible rotary electric machine 3 comprises an external stator 8 and an internal rotor 9. The external stator 8 of the electric machine surrounds the internal rotor 9. An annular air gap space 300 extends between the internal periphery of the stator 8 and the external periphery of the rotor 9. The rotor 9 has a central opening allowing the passage of the intermediate shaft 7.

The stator 8 is borne by a support element 16 which is, on the one hand, intended to be fixed to the engine block and, on the other hand, intended to be fixed to the gearbox casing 17. The support element 16 is inserted between the gearbox casing and the engine block and is designed to allow the gearbox to be fixed to the engine block. In other words, the support element forms a kind of spacer between the engine block and the casing 17 of the gearbox.

The support element 16 comprises an external peripheral wall 18 the internal surface of which is cylindrical in shape so as to collaborate with the external periphery of the stator 8. The mounting of the stator 8 inside the support element 16 may be performed by shrink fitting or force fitting. The support element 16 also has an internal web 19, extending in front of the stator 8 and of the rotor 9 and forming a dividing wall between the clutch 1 on the engine side on the one hand, and the electric machine 3 on the other. The distance between the internal web 19 and the rotor 9 is optimised so as to avoid losses or induced current that cause reductions in the power of the electric machine.

The support element 16 also defines a housing 201 extending inside the rotor 9 and into which the clutch bearing 100 of the clutch 1 on the engine side at least partially extends. Such an arrangement makes it possible to optimize the axial bulk of the assembly. The housing 201 is defined by an axial skirt 205 and an end wall 212 of radial orientation. The end wall 212 is provided with a bore 202 allowing the intermediate shaft 7 to pass.

Moreover, an axial rim 211 extends from the end wall 212 of the housing, towards the rear, and with the rear face of the end wall 212 of the housing 201 forms a cylindrical bore to house a rolling bearing 20. In other words, the end wall 212 of the housing 201 delineates, on the engine side, the cylindrical bore for housing the rolling bearing 20 and defines a front radial bearing surface for the rolling bearing 20.

The rolling bearing 20 moreover collaborates with the intermediate shaft 7 by virtue of a shoulder which defines a rear bearing surface for the rolling bearing 20. The rolling bearing 20 thus allows the intermediate shaft 7 to be centred with respect to the support element 16.

In one embodiment, not depicted, the front end of the intermediate shaft 7 is mounted in the crankshaft of the combustion engine via a pilot rolling bearing mounted in a cavity in the nose of the crankshaft.

The rolling bearing 20 comprises an external ring, an internal ring, and rolling bodies extending between the said external and internal rings. The external ring is axially coupled to the support element 16 whereas the internal ring is axially coupled to the intermediate shaft 7. In this way, the rolling bearing is axially fixed with respect to the support element 16, on the one hand, and to the intermediate shaft 7 on the other. Furthermore, such a mounting of the rolling bearing 20 allows the intermediate shaft 7 to be held axially with respect to the support element 16.

In order to couple the internal and external rings axially, these rings may be force-fitted or bonded. Alternatively, it is also possible to use one or more blocking members, such as elastic snap rings or circlips, not depicted. For that, the intermediate shaft 7 is equipped with a fixing groove extending in front of the rolling bearing 20. During an operation of fixing the rolling bearing 20 in place, a blocking member such as a snap ring or a circlip is arranged, by elastic deformation, in a fixing position in the said fixing groove so as to limit the axial movement of the rolling bearing 20 in the forwards direction. In the same way, the support element 16 may have a fixing groove extending to the rear of the rolling bearing 20 and able to accept a blocking member. The blocking member is arranged by elastic deformation in the fixing groove of the support element 16 and allows the rearwards axial movement of the rolling bearing 20 to be limited. In an intermediate embodiment, one of the rings, external and internal, is force-fitted or bonded whereas the other ring is held in place axially by a blocking member housed in a groove.

The support element 16 is, for example, made of metal. It may notably be made of a material that can be cast, for example being made of aluminium or an aluminium-based alloy. It is preferably made of a nonmagnetic material.

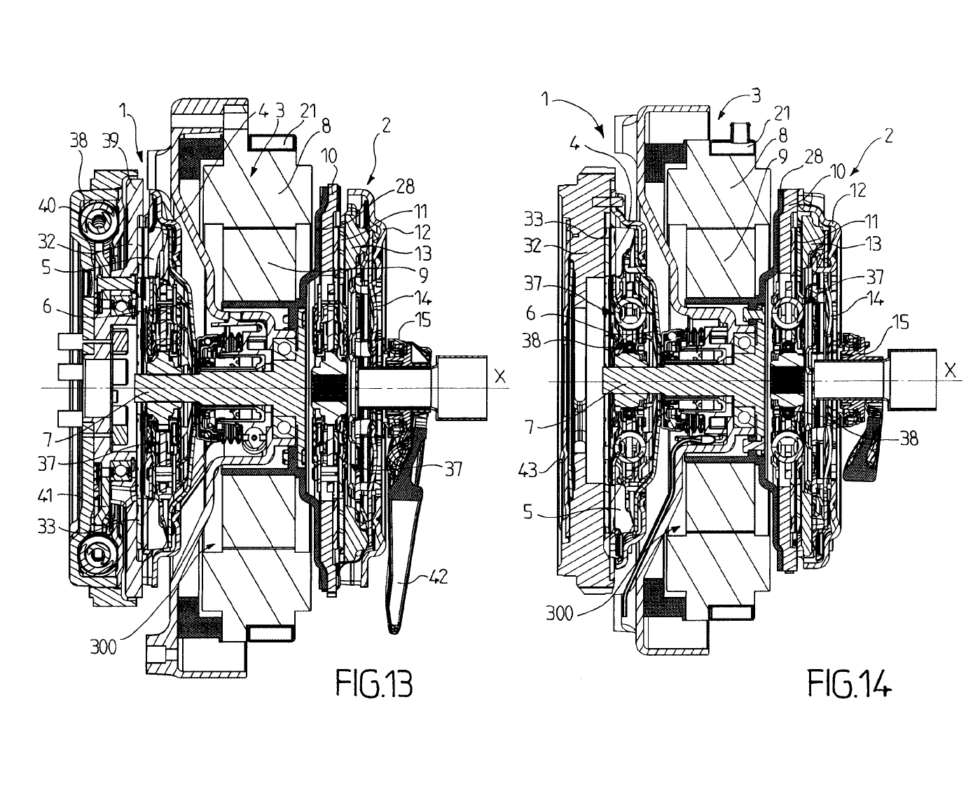

In one embodiment, the support element 16 has a cooling circuit 21 for cooling the stator 9. For that, it is possible to create, by sand-casting, an annular shape in the external peripheral wall 18. This cooling circuit 21 has an inlet and an outlet allowing the circulation of a liquid coolant. Alternatively, as illustrated in FIGS. 13, 14 and 15, it is also possible to obtain such a cooling circuit using an added tube.

The rotor 9 is supported by a hub 22. The hub 22 comprises an axial skirt 26 for supporting the rotor 9. The axial skirt 26 on its exterior surface comprises a radial shoulder 27 defining a bearing surface for the rotor 9. The rotor 9 comprises laminations. It is shrink-fitted onto the external surface of the axial skirt 26. Thus, the laminations are fitted in the hot state onto the external surface of the axial skirt 26 until they come into contact with the radial shoulder 27. In another embodiment, the rotor 9 may be force-fitted onto the external surface of the axial skirt 26.

The hub 22 further comprises an annular radial web 28 extending to the rear of the stator 8 and of the rotor 9 and bearing the reaction plate 10 of the clutch 2 on the gearbox side. The reaction plate 10 is fixed to the annular radial web 28 outside of the annular zone of friction of the reaction plate 10 which is intended to collaborate with the friction linings of the friction disc 11 when the clutch is in the engaged position. The reaction plate 10 is, here, fixed to the annular radial web 28 in an external peripheral region extending radially beyond the friction zone.

The reaction plate 10 is fixed at an axial distance from the electric machine 3. Thus a space is left between the reaction plate 10 and the electric machine 3.

The axial skirt 26 has an axial portion 29 extending between the radial bearing shoulder 27 for the rotor and the annular radial web 28 so as to define a gap between the annular web 28 and the rotor 9. In other words, the region of connection of the annular web 28 to the axial skirt 26 is offset axially with respect to the rotor 9 so as to avoid magnetic leakage.

The annular web 28 comprises a cambered portion 30 extending between two annular planar portions. This cambered portion 30 notably allows the annular web 28 to be given a degree of flexibility allowing the rotor 9 to be uncoupled from the reaction plate 10 by flexing.

The support hub 22 supporting the rotor 8 is fixed to the intermediate shaft 7. To do that, the rear end of the intermediate shaft 7 comprises a collar 23 which comes to press axially against an internal flange 25 formed in the support hub 22 and extending radially towards the inside of the axial skirt 26. Rivets 24 join together the collar 23 of the intermediate shaft 7 and the internal flange 25 of the hub 22. In this way, the rotor 9 is centred with respect to the support element 16 and therefore with respect to the stator 8 by way of the rolling bearing 20.

The hub 22 is made of steel or iron sheet. Making the said hub 22 from sheet metal on the one hand makes shrink-fitting the rotor 9 on to the hub 22 easier and on the other hand makes it possible to limit the conduction of heat energy produced by friction by the clutch 2, towards the rotor 9.

In order to limit the conduction of heat energy generated by the friction of the clutch 2, it is also possible to provide an additional layer of a material having low thermal conductivity which is arranged at the interface between the annular radial web 28 and the reaction plate 10. The additional layer may be a layer of plastic, based on polyphenylene sulphide or on polyamide 6-6, for example, or a sheet of paper of the “DMD” type, consisting of a polyester film and of an impregnated nonwoven coating covering each of the faces of the polyester film.

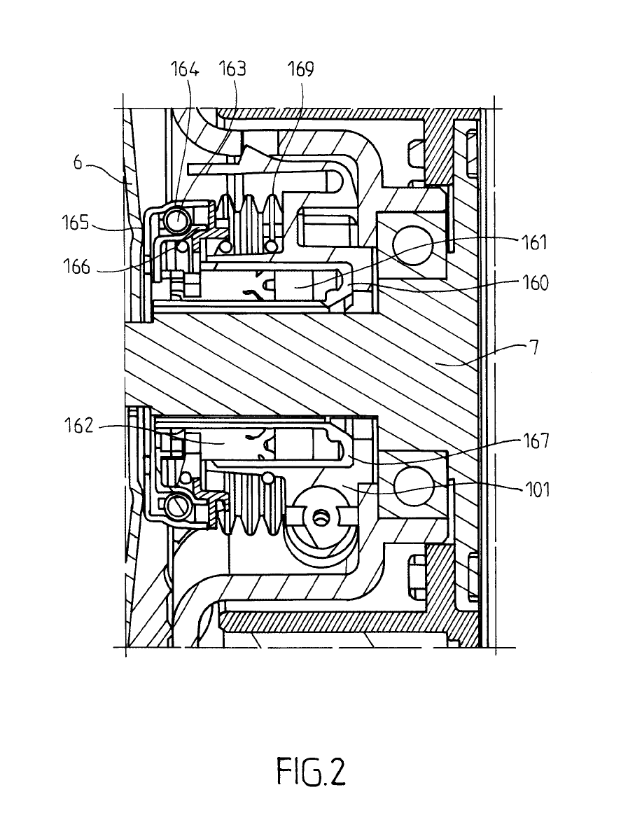

With reference to FIGS. 2 to 10, a clutch bearing 100 for actuating the clutch 1 on the engine side, and its assembly inside the housing 201 of the support element 16 will now be described in detail.

The clutch bearing 100 is a fluidically operated thrust bearing. The fluid may be a hydraulic fluid or a pneumatic fluid. The operating fluid is usually oil. In one embodiment, the thrust bearing may also be an electrically operated thrust bearing.

The thrust bearing 100 is concentric with the axis X and has the intermediate shaft 7 passing through it. The thrust bearing 100 comprises two parts in a cylinder piston relationship, namely a fixed part 160 delimiting a blind annular cavity of axial orientation, and a piston 162 mounted with the ability to move axially with respect to the fixed part 160. The piston 162 enters the cavity in order therewith to define a variable-volume working chamber 161. The cavity communicates via a duct with an inlet for connection to a fluid supply pipe connected to a master cylinder. The master cylinder is actuated by an electric motor actuator or a pressure/volume generator controlled in accordance with programs predetermined by a computer. The working chamber 161 is therefore allowed to be pressurized or depressurized.

In the embodiment depicted, the fixed part 160 of the thrust bearing 100 comprises a guide tube 167 and an outer body 101 surrounding the guide tube 167. The guide tube 167, for example made of metal, defines the annular cavity in which the piston 162 is able to move and thus guides the piston 162. The guide tube 167 is assembled with the body 101. The guide tube 167 has the intermediate shaft 7 passing through it.

Alternatively, the fixed part 160 could be a single piece of a mouldable material, for example a plastics material, the body 101 then defining the annular cavity in which the piston can move 162.

The clutch bearing 100 is of the self-aligning type here. It comprises a ball bearing 163 with a rotating ring 164 that is shaped for point contact with the internal ends of the fingers 165 of the diaphragm 6 and a non-rotating ring 166 coupled axially to the piston 162. For greater details regarding the self-aligning of the thrust bearing reference may for example be made to document FR-A-2619880. A sealing gaiter 169 extends between the body 101 and the non-rotating ring 166. As an alternative, the thrust bearing is of the pulled type, the thrust bearing 100 then working by pulling on the fingers of the diaphragm.

In one embodiment, the clutch bearing 100 is equipped with a position sensor that allows the position of the piston 162 with respect to the body 101 to be monitored. The position sensor may be a sensor incorporated in the piston or may be installed in the actuator that controls the clutch bearing 100.

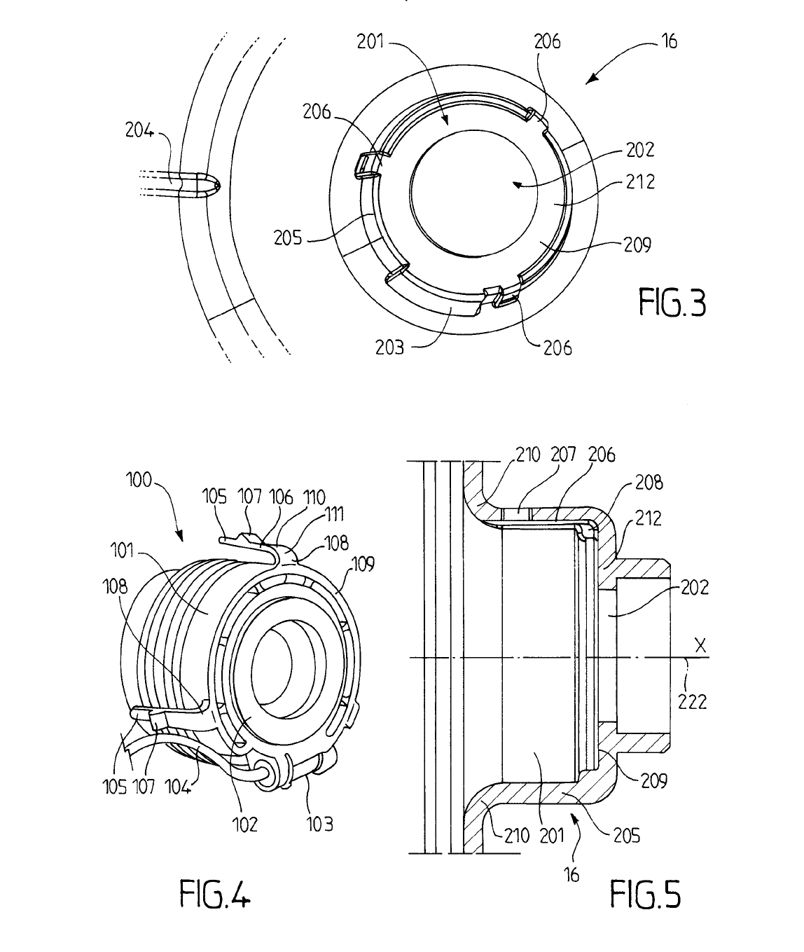

The housing 201 of the support element 16, intended to at least partially accept the clutch bearing 100 of the clutch 1 on the engine side will now be described with reference to FIGS. 3 to 5.

As mentioned previously, the housing 201 is defined by an end wall 212 and an axial skirt 202. The end wall 212 is pierced with a bore 202 that allows the intermediate shaft 7 to pass through. The axis of the bore 202 is coaxial with the axis X of rotation of the assembly.

The axial skirt 205 comprises a recess 203 to allow the passage of a connection end piece 103 for connection to a pipe supplying the thrust bearing 100 with operating fluid. Moreover, the internal web 19 of the support element 16 comprises a recess 204 for the passage of the pipe supplying the clutch bearing 100 with fluid. The recess 204 devoted to the passage of the operating pipe is slightly oversized in relation to the diameter of the supply pipe.

To facilitate placement of the clutch bearing 100, the axial skirt 205 comprises guide grooves 206 which are intended to collaborate with elastic locking tabs 106 described later. The guide grooves 206 are parallel to a generatrix of the axial skirt 205.

In one embodiment, the guide grooves 206 also act as poka-yoke features so that only one angular position for the mounting of the clutch bearing 100 in the housing 201 is allowed. In this way, the guide grooves 206 allow the clutch bearing 100 to be positioned angularly with respect to the housing 201 in such a way as to position the connection end piece 103 of the clutch bearing 100 facing its respective recess 203. In order to achieve this result, the angular distribution of the grooves 206 is uneven. In other words, there are at least two different angular distances between two adjacent grooves 206.

To make it easier to insert the elastic locking tabs 106 in the housing 201, the front end of the longitudinal edges of the grooves 206 may comprise chamfers to compensate for a positioning discrepancy of a few degrees as the elastic locking tabs 106 are inserted into the grooves 206. Likewise, the grooves 206 have a width and/or a depth which is greater at their front end than at their rear end so as to make it easier to insert the elastic locking tabs 106. In such an arrangement, variations in the slope of the longitudinal edges or of the radially exterior edge may be linear or nonlinear.

The axial skirt 205 also comprises cavities 207 to accommodate a protuberance 107 borne by an elastic locking tab 106. The cavities 207 here extend into the end walls of the guide grooves 206.

In order to hold the clutch bearing 100 in position angularly and prevent any rotation of the clutch bearing 100 with respect to the housing 201 as a result of the drag torque of the thrust rolling bearing, the housing 201 is provided, near its end wall, with tangential stops 208 intended to collaborate with the elastic locking tabs 106. In the embodiment, the stop surfaces of the tangential stops 208 bordering each groove are parallel in pairs and symmetric about a midplane passing through the axis X.

At the entrance of the axial skirt, the edge corner formed between the axial skirt 205 and the internal web 19 is softened by a fillet 210. In another embodiment, the edge corner is softened by a chamfer. These arrangements make it easier to insert the clutch bearing 100 inside the housing 202.

Finally, the end wall 212 of the housing 201 comprises a bearing face 209 against which the clutch bearing 100 can press axially.

FIG. 4 is a perspective view of one embodiment of a clutch bearing 100 illustrating means of fixing the clutch bearing 100 in the housing 201.

The body 101 or casing is provided with elastic locking tabs 106. An elastic tab 106 comprises a proximal end for connection to the body 101 and a distal end that is free. The elastic tab 106 has an L shape and comprises a radially oriented portion 108 extending from its proximal end and an axially oriented portion 110. The proximal end for connection to the body 101 is situated near the rear end of the body 101 and the axially oriented portion 110 extends forwards, i.e. in a direction away from the end wall 212 of the housing 201. The elastic tab 106 is provided with a protuberance 107 able to collaborate with a respective locking cavity 207. The protuberance 107 extends radially outwards, from the axially oriented portion 110.

The elastic tab 106 formed in this way has the ability to flex radially about the junction between the radially oriented portion 108 and the axially oriented portion 110. This radial flexibility of the elastic tab 106 allows the protuberance 107 to move radially. Thus, when the clutch bearing 100 is being assembled on the support element 16, the elastic tab 106 deforms radially inwards by contact of the protuberance 107 with the axial skirt 205 and then is returned outwards, towards a locking position, when the protuberance 107 becomes lodged in its respective cavity 207.

Let it be noted that the body 101 is advantageously made of a material able to confer upon the elastic tabs 106 sufficient capacity for elastic deformation. By way of example, the body 101 may notably be made of a plastics material, such as polyamide 6-6, possibly with fillers added.

Moreover, the elastic tabs 106 are arranged in such a way as to allow an operator to unlock the fixing of the clutch bearing 100 in order to extract same from its housing 201, during a maintenance operation for example. To do this, the protuberance 107 extends in a middle portion of the elastic tab 106. Thus, radially inwards pressure on the free distal end of the elastic tab 106 moves the protuberance 107 from its locked position, in which it extends into the locking cavity 207, into a released position in which it extends radially outside of the cavity 207. In other words, the distal portion of the elastic tab 106 which extends beyond the protuberance 107 constitutes an unlocking finger 105 allowing an operator to influence the radial travel of the tab 106. In this way, this operator can easily unlock the clutch bearing 100 in order to be able to extract same from its housing 201.

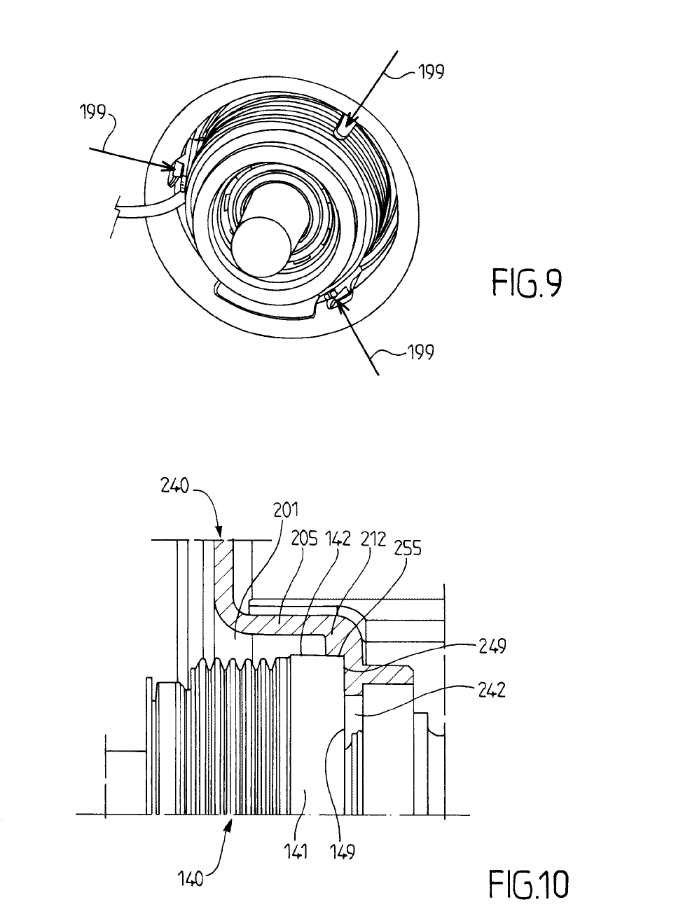

In the embodiment depicted, the protuberance 107 has the shape of a tooth. The rear face 117 is inclined in such a way as to make insertion of the clutch bearing 100 into the housing 202 easier. The inclination with respect to the axis X is preferably less than 45°. The front face 127, on the distal end side, also has an inclination the function of which will be detailed in FIG. 9. The inclination of the front face 127 with respect to the axis X is preferably greater than 45°.

Finally, the body 101 comprises a connection end piece 103 to allow connection to a supply of fluid for operation of the clutch bearing 100. In this embodiment, operation is achieved using a pneumatic or hydraulic fluid carried by a line, in this instance a flexible or rigid supply pipe 104.

The body 101 comprises a shoulder 109 to ensure that the clutch bearing 100 presses axially against the end wall 212 of the housing 201. The body 101 also comprises a cylindrical reduction 102 collaborating with the bore 202 formed in the end wall 212 of the housing 201. This reduction serves to position the clutch bearing 100 on the support element 16. To perform this centring this cylindrical reduction 102 is coaxial with the reference axis X.

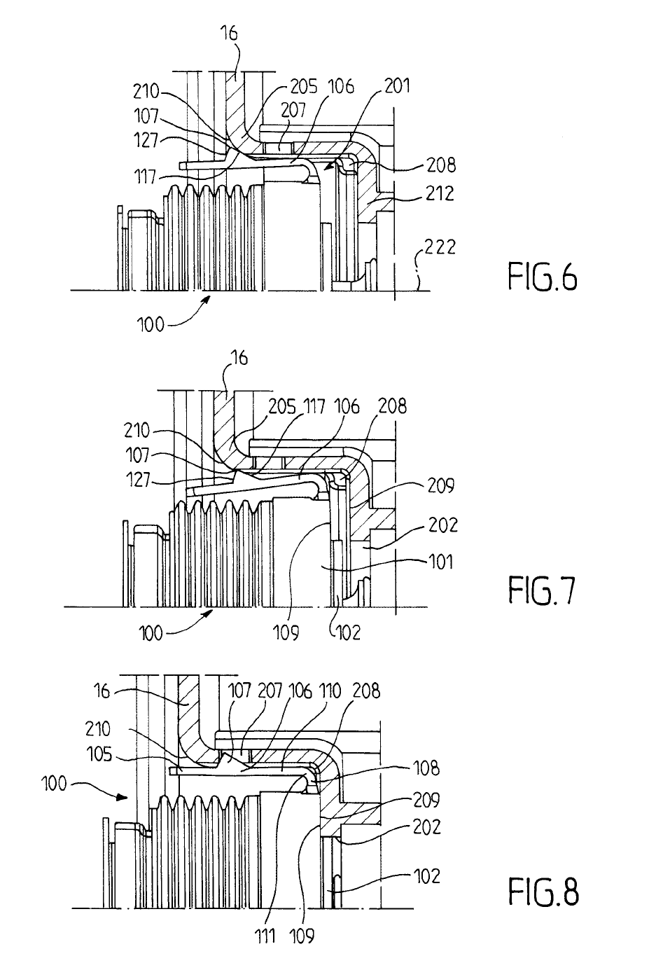

FIGS. 6 to 8 depict the three steps of mounting the clutch bearing 100.

In a first step, the clutch bearing 100 is offered up to the housing 201, observing the poka-yoke feature afforded by the elastic tabs 106 and the grooves 206. When the protuberance 107 comes into contact with the support element 16, the fillet 210 at the entrance to the housing 202 presses against the front face 117 of the protuberance. The inclination of the front face 117 of the protuberance 107, combined with the shape of the fillet 210, allows the elastic tab 206 to be deformed gradually to bend the distal end over towards the central axis of the thrust bearing 100 and promote insertion of the latter. The shape of the entrance to the housing and the inclination of the front face 117 of the protuberance 107 therefore contribute to making insertion easier without the need for the operator to press on the elastic tabs 106.

In a second phase, the clutch bearing 100 is pushed along the reference axis X as far as the end wall of the housing 201 so that the cylindrical reduction 102 enters the bore 202 and then so that the shoulder 109 is pressed against the bearing face 209. To make insertion of the cylindrical reduction 102 into the bore 202 easier, the cylindrical reduction and the bore 202 have complementing conical chamfers.

During this insertion phase, the tab 106 remains in radially flexed position, under the effort exerted by the end wall of the groove 206 of the axial skirt 205.

During the final step, when the clutch bearing 100 has reached its mounted position, in abutment against the end wall 212 of the housing, the protuberance 107 is facing the cavity 207. The tab 106, by virtue of its elasticity, reverts to its rest shape and the protuberance 107 enters the cavity 207, thereby axially immobilizing the clutch bearing 100. In other words, the locking tab 106 serves to clip the clutch bearing 100 into the housing 201 of the support element 16.

In this position, the radially oriented portion 108 presses against the tangential stop 208 in order to hold the clutch bearing 100 angularly in position. The tangential stop 208 means that angular retention need not be performed between the protuberance 107 and its cavity 207 because given the positioning of the protuberance 107, a tangential force applied on the protuberance would generate a lever arm effect and cause the base of the elastic tabs 106 to become twisted in a way liable to cause them to break.

In the mounted position, the distal end of the elastic tabs 106 extends axially beyond the axial skirt 205. Such an arrangement makes unlocking operations easier. By way of an alternative, the elastic tab 106 is shorter and does not protrude outside of the housing 201. That arrangement is notably adopted in cases where there were problems with space.

To remove the clutch bearing 100, with reference to FIG. 9, a radial force 199 needs to be applied to the distal end that forms a finger 105 of the elastic tabs 106, from outside the thrust bearing 100 towards the central axis thereof so as to move the protuberances 107 towards their released position in which they extend outside of their cavity 207. The front face 127 of the protuberance 107 has an inclination which facilitates unlocking when a radial force 199 is applied. Once the thrust bearing is no longer immobilized in its housing 201 by the protuberances 107 it need merely be extracted by pulling the axial skirt 205 forwards.

FIG. 10 depicts another embodiment of the function of centring/aligning the body 101 with respect to the housing 201 and creating pressure of the one against the other. In FIG. 9, elements identical to those of FIGS. 3 to 9 bear the same reference numeral. Analogous elements that have been modified bear the same reference numeral increased by 40.

In this embodiment, the end wall 212 of the housing 201 comprises a shoulder forming a centring bore 255 and a radial surface 249 against which the body 141 of the thrust bearing 100 presses axially. The outer case 142 of the body 141 of the clutch bearing 140 is cylindrical so as to perform the self-alignment function with the bore 255 present in the end wall 212 of the housing 201. As with the previous embodiment, the cylindrical case 142 and the bore 255 are coaxial with the axis X of the assembly. To provide axial retention, the body 141 at its rear end comprises a bearing surface 149 which butts against the end wall of the bore 249.

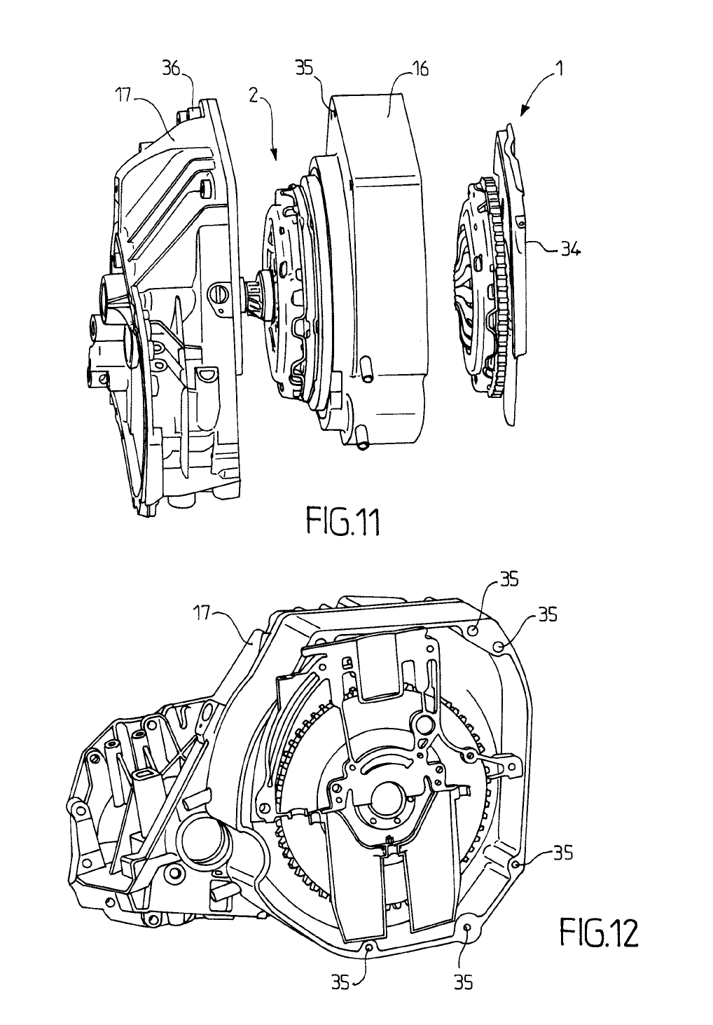

FIGS. 11 and 12 illustrate the method for assembling a transmission assembly.

The clutch 1 on the engine side is fixed to the engine block 34. To do that, the flywheel bearing the reaction plate 32 is fixed to the crankshaft of the combustion engine using screws and then the mechanism and the friction disc 33 of the clutch 1, on the engine side, are mounted on the flywheel. Alternatively, it is also possible to preassemble a module comprising a flywheel, a clutch mechanism and a friction disc 33, then mount the said module on the combustion engine crankshaft.

Furthermore, a module comprising at least a support element 16, the clutch bearing 100 for actuating the clutch 1 on the engine side, the intermediate shaft 7, an electric machine 3 and the reaction plate of the clutch 2 on the gearbox side is preassembled. Preassembling such a module makes it easier to mount the whole when assembling the transmission with the engine block.

In the embodiment depicted, the preassembled module further comprises the mechanism, i.e. the cover 12, the pressure plate 13 and the diaphragm 14, as well as the friction disc 11 of the clutch 2 on the gearbox side.

This preassembled module can be handled and easily transported, the elements of the said module being axially fixed and centred relative to one another, notably by way of the rolling bearing 20.

The support element 16 comprises fixing orifices 35 passing all the way through the said support element 16. These fixing orifices 35 open to face orifices 36 formed in the casing 17 of the gearbox and to face orifices, not depicted, formed on the engine block or on a spacer for connection to the engine block. Thus, fixing screws, not depicted, are inserted through the said orifices 35, 36 in order to connect the gearbox, the preassembled module and the engine block.

In one embodiment, the preassembled module is prepositioned on the engine block, using centring pins or bushings, for example, then the casing 17 of the gearbox is brought up against the support element 16 and the screws are inserted through the orifices 36 in the casing, the orifices 35 in the support element 16 and the orifices in the engine block so as to join the assembly together.

In an alternative embodiment, it is also possible to preposition the preassembled module on the casing 17 of the gearbox then to bring the gearbox and preassembled module onto the engine block.

In another embodiment, a first group of fixing orifices 35 can be used for the passage of screws intended to fix the preassembled module to the gearbox while a second group of fixing orifices 35 can be used for the passage of screws intended to fix the preassembled module to the engine block 34.

In one embodiment, it is also possible to use studs with two threaded ends to allow the preassembled module to be mounted on the casing 17 of the gearbox via the first end of the said studs and on the engine block 34 via the second end of the said studs.

As depicted in FIGS. 13, 14 and 15, the friction discs 11, 33 are advantageously fitted with torsion dampers 37. Typically, such a torsion damper 37 comprises two guide roundels rotating as one with a friction linings support disc and forming the input element of the damper. The guide roundels are arranged one on either side of a web forming the output element of the damper. Circumferentially acting elastic members such as helical springs are mounted in housing openings made, facing each other, in the guide roundels and in the web. The ends of the helical springs bear against the radial edges of the housing apertures so that the said helical springs are able to transmit a torque between the guide roundels and the web.

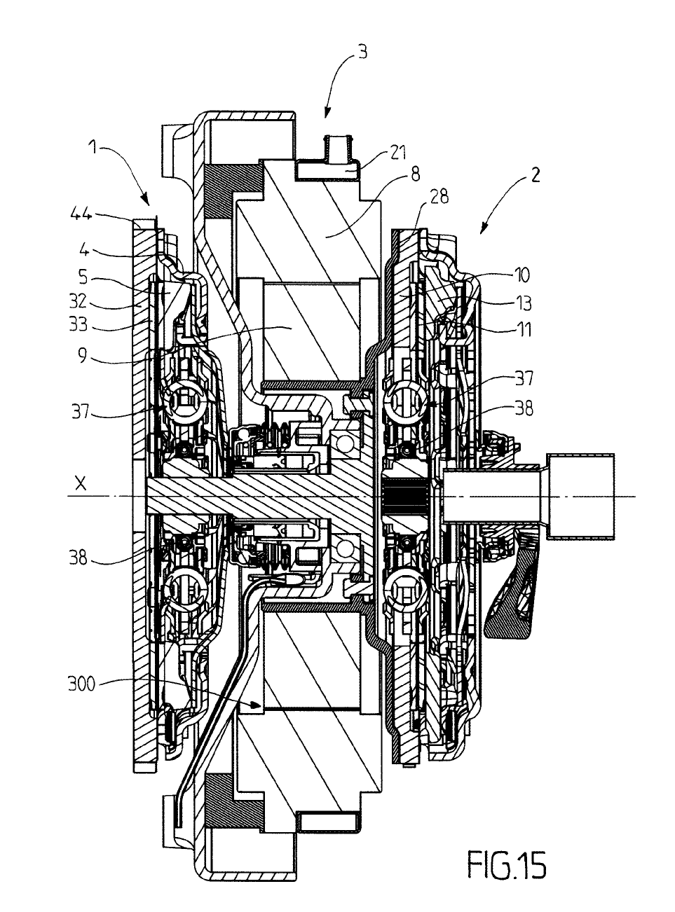

The friction discs 11, 33 may also be fitted with a pre-damper 38 intended to filter out vibrations caused by acyclic running of the combustion engine at idling speed. Such pre-dampers, notably depicted in FIGS. 14 and 15, have small-sized helical springs of lower spring rate than the springs of a main damper.

In the embodiment depicted in FIG. 13, the reaction plate 32 of the clutch 1 on the engine side constitutes the secondary mass 39 of a double damping flywheel. The double damping flywheel comprises a primary flywheel 38 and a secondary flywheel 39 which are coaxial, and able to rotate the one with respect to the other by virtue of a bearing such as a ball bearing. The primary flywheel 38 is intended to be fixed to the crankshaft of the combustion engine, for example using screws. The primary flywheel 38 and the secondary flywheel 39 are coupled in rotation by damping means. The damping means are typically helical springs 40 arranged circumferentially in an annular chamber formed in the primary flywheel 38 and filled with a lubricant. The helical springs 40 press at their ends against bosses on the lateral walls of the annular chamber and on radial tabs of an annular web 41 fixed by rivets to the secondary flywheel 39.

FIG. 13 moreover illustrates a clutch fork 42 able to pivot in order to move the thrust bearing of the clutch 2 on the gearbox side.

In the embodiment of FIG. 14, the reaction plate 32 of the clutch 1 on the engine side is fixed to a flexible annular sheet 43 which is intended to be fixed to the crankshaft of the combustion engine, for example using screws. A Belleville washer acts between the reaction plate 2 and the flexible sheet 43. Such a flywheel is commonly referred to as a flexible flywheel and provides damping of the axially directed excitations of the crankshaft.

In the embodiment of FIG. 15, the reaction plate 32 of the clutch 1 on the engine side is borne by a rigid flywheel intended to be fixed to the crankshaft of the engine.

It will be noted that in the embodiments of FIGS. 1 and 15, the flywheel has, on its external periphery, a ring gear 44 intended to collaborate in meshing with the pinion of a starter motor. Such a starter may be used, to complement the electric machine 3, for starting the combustion engine, notably in very cold weather, as described in document FR 2 797 472, to which reference may be made for further information of this subject.

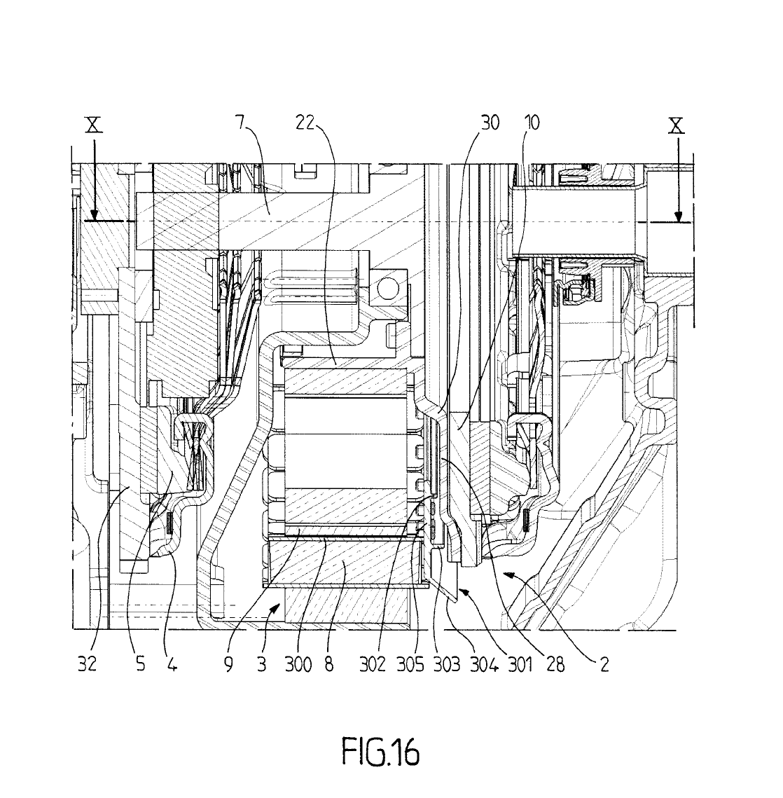

As mentioned previously, the reaction plate 10 is axially distant from the elements of the electric machine 3, thereby creating an axial space between the reaction plate 10 and the electric machine 3. With reference to FIGS. 16 and 17, a dust flange 301 intended to protect the electric machine from particles of dust, notably originating from the clutch 2 and liable to enter via the abovementioned axial space will now be described. These particles are notably generated as the friction linings of the friction disc 11 rub between the reaction plate 10 and pressure plate 13.

This flange 301 is intended to prevent dust from reaching the annular gap space 300 between the rotor 9 and the stator 8. This is because were such particles to enter the annular gap space 300 they could damage the rotor 9 and the stator 8 by abrasion by acting as abrasive particles between the stator 8, which is a fixed component, and the rotor 9, which is a moving component.

In order to avoid that, the flange 301 is arranged in the space between the electric machine 3 and the reaction plate 10 and more particularly between the reaction plate 10 on one side and the rotor 9/stator 8 assembly on the other. The flange 301 takes the form of a washer the external periphery and the internal periphery of which are defined by two concentric circles.

The flange 301 is fixed to the stator 8. Its internal periphery extends radially inwards beyond the annular gap space 300 so as to cover it. The flange 301 comprises a radially directed cheek and two lips 302 and 303 which extend axially towards the reaction plate 10. The lips 302 and 303 block the passage of dust into the space between the electric machine 3 and the reaction plate 10. Advantageously, the axial distance between the end of the lips 302, 303 and the reaction plate 10 or the annular radial web 28 supporting the reaction plate 10, when the annular radial web 28 is arranged between the reaction plate 10 and the electric machine 3, is limited to a functional clearance, typically less than 5 mm.

As FIG. 16 shows, the axial distance between the annular radial web 28 and the electric machine 3 is not constant. The space or axial distance between the annular radial web 28 and the stator 8 is greater than the space between the annular radial web 28 and the rotor 9. The internal lip 302 is arranged level with the rotor 9 in the smallest space, while the external lip 303 is positioned in the larger space level with the stator 8. The axial dimension of this external lip 303 is greater than the dimension of the smallest space. With this arrangement, the internal lip 302 and the external lip 303 find themselves on either side of the annular gap space 300 and form a labyrinth further obstructing the passage of dust into the space between the reaction plate 10 and the electric machine 3.

The flange 301 also comprises a deflector 304 arranged at the external periphery of the cheek 305 and forming a frustoconical edge, flared outwards, towards the clutch 2. This deflector allows dust generated by the clutch 2 on the gearbox side to be confined between the gearbox and the electric machine 3.

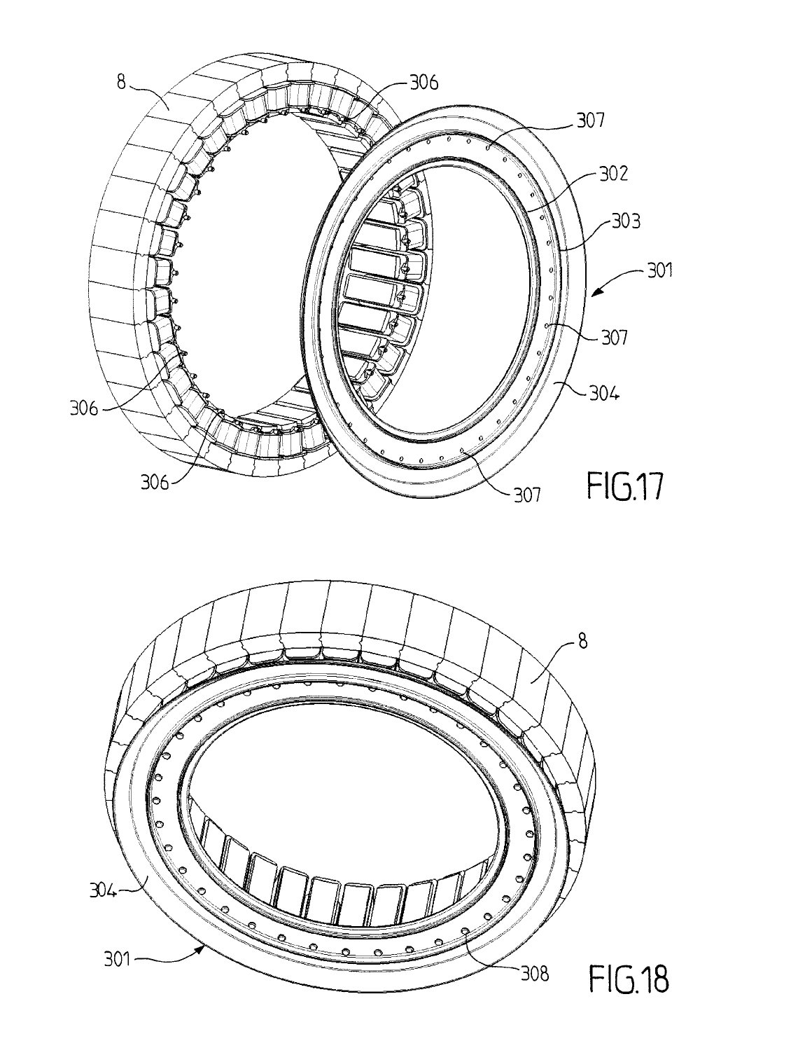

The attachment of the flange 301 to the electric machine 3 and more specifically to a fixed part of the electric machine 3, namely the stator 8, will now be described with reference to FIGS. 17 and 18.

To do that, the stator 8 is equipped with pegs 306 projecting axially from its lateral part, on the gearbox side. The pegs 306 are configured to collaborate with open-ended holes 307 formed on the flange 301. During the assembly step, the holes 307 and the pegs 306 are used to position the flange 301 with respect to the stator 8. Thus, the flange 301 is coaxial with the electric machine 3.

In one embodiment, the pegs 8 are borne by the body of an interconnector, which will be described later on, that allows the coils of the stator 8 to be connected.

The pegs 306 are evenly distributed along the annular gap space 300. After the flange 301 has been inserted over the pegs 306 of the stator 8, the pegs 306 protrude beyond the flange 301 through the holes 307. Fixing is achieved for example by ultrasonically welding the pegs 306 so that there is obtained, at the end 308 of the pegs, a head the dimensions of which exceed the diameter of the hole 307. In this way, the flange 301 is held immobilized, non-removably, on the stator 8. In order to allow this mode of assembly, the pegs 306 are made of a hotmelt material, such as a thermoplastic. By way of example, the pegs may notably be made of polyamide 6-6.

In one embodiment, the flange 301 is made of a nonmagnetic material. By way of example, the flange 301 may notably be made of plastic. Such a flange makes it possible to limit magnetic leakage to the reaction plate 10 or to the annular radial web 28 supporting the reaction plate 10 when the annular radial web 28 is arranged between the reaction plate 10 and the electric machine 3.

In another embodiment, the flange 301 constitutes a magnetic screen between the electric machine 3 and the clutch 2, on the gearbox side, able to concentrate the lines of the magnetic field and limit the leakage field. To do that, the flange 301 may notably be made of a plastics material associated with nonmagnetic metallic fillers, such as particles of aluminium. Such a flange advantageously has a magnetic susceptibility of less than 1×10⁻³.

FIG. 19 illustrates the stator 8 of an electric machine 3 capable of equipping the transmission assembly. The stator here belongs to a multiphase rotary electric machine. The winding of the stator 8 is equipped with several concentric coils 45, in this instance preformed, and with a neutral point, referred to as the machine neutral, visible for example in FIG. 1 of document EP 0 831 580. This stator is compact and high-performance from the standpoint of the power of the electric machine.

The coils 45 are interconnected with one another using a compact interconnector 46 having several frames, of which one, referred to as the neutral frame, is connected to the neutral of the rotary electric machine. This stator 8 comprises a body of annular shape the axis of which coincides with the axis X. This body has teeth 47 distributed evenly on the internal periphery and slots 48 open towards the inside, two consecutive slots 48 being separated by a tooth 47. These teeth 47 have edges that are parallel in pairs, a strip of material, corresponding to the yoke 53 being present between the end walls of the slots 48 and the external periphery of the body 49. The body 49 is formed of a stack of annular laminations made of ferromagnetic material coaxial with the axis X. The set of laminations is held by rivets (not depicted) passing axially right through the stack of laminations. These laminations make it possible to reduce eddy currents.

The stator 8 comprises an interconnector 46 with connection terminals U, V and W for interconnecting with a power connector.

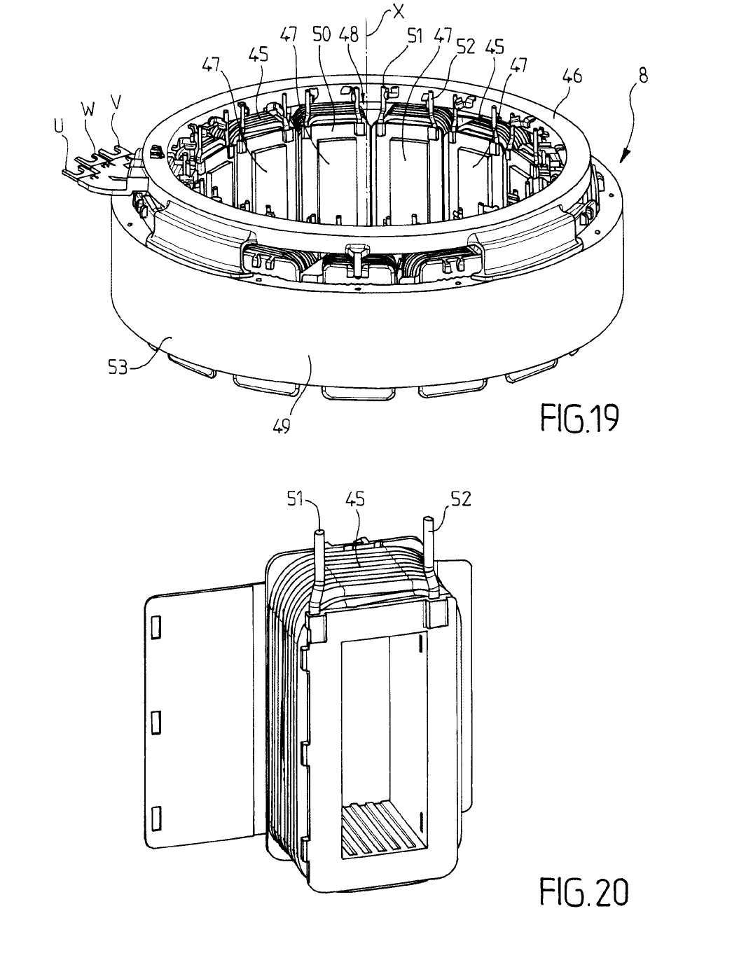

As can be seen in FIG. 20, preformed coils 45 that form the windings of the stator 8 are mounted on the teeth 47 of the stator. These coils 45 are made from a wire wound in several turns. The wires consist of an electrically conducting wire, for example a copper and/or aluminium wire, coated with an electric insulator such as enamel. The wires may be of circular or rectangular cross section or may be flatted. The ends 51, 52 of each coil 50 protrude axially from the winding on one and the same side of the stator 8 corresponding to the rear face of the stator 8. Each coil 45 comprises a first end 51 referred to as the “input” intended to be connected to the other inputs alternately in order to belong to one of the phases, each one having a respective terminal U, V, W of the machine, and a second end 52 referred to as the “output” intended to be connected to the neutral of the electric machine. For that, the coils 45 are interconnected with one another using the interconnector 46.

The interconnector 46 in this embodiment comprises four frames of annular shape extending in a radial plane. The frames are electrically conducting for example being made of copper or advantageously of another metallic material that can be welded or soldered. These frames are stacked axially on one another and electrically insulated from one another. Each frame on its internal periphery bears visible tabs extending as a radial projection towards the inside of the frame for soldering the ends 51, 52 of the stator coils. For preference, the frames are embedded in a body made of an electrically insulating material, such as plastics material. Each phase frame on its external periphery comprises a connection terminal U, V, W for interconnection with a power connector (not depicted) itself connected to an inverter described for example in document EP 0 831 580. As an alternative, the inverter is controlled by signals as in document FR 2 745 444.

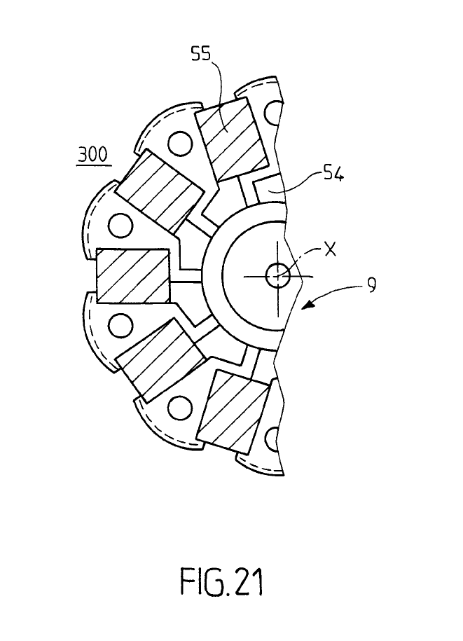

The electric machine 3 is a synchronous machine. A permanent-magnet rotor 9 intended to equip the electric machine is illustrated in FIG. 21. The rotor comprises a body formed of a set of laminations 54 stacked in the axial direction. The permanent magnets 55 are installed radially in the laminations 54 of the set of laminations 54, at the external periphery of the rotor 9. The permanent magnets 55 open onto the gap 300. This then is referred to as an open-pole permanent-magnet rotor. Such a rotor makes it possible to obtain a high level of useful magnetic flux.

In one embodiment the permanent magnets are ferrite magnets. Several permanent magnets may be mounted in one and the same opening of the set of laminations.

Although the invention has been described in conjunction with a number of particular embodiments it is quite obvious that it is not in any way restricted thereto and that it comprises all technical equivalents of the means described and combinations thereof where these fall within the scope of the invention.

The use of the verb “to have”, “to comprise” or “to include” and of the conjugated forms thereof does not exclude the presence of elements or steps other than those listed in a claim. The use of the indefinite article “a/an/one” for an element or a step does not, unless mentioned otherwise, exclude the presence of a plurality of such elements or steps.

In the claims, any reference sign between parentheses must not be interpreted as implying limitation on the claim.

1. Preassembled module for a motor vehicle transmission assembly intended to be arranged between an engine block and gearbox, comprising:
a support element (16) provided with fixing elements for fixing to the engine block and/or to the gearbox;
a clutch bearing (100), mounted on the said support element (16), intended to actuate a clutch (1) on the engine side;
an intermediate shaft (7) with the ability to rotate, comprising a splined end intended to collaborate with a hub of a friction disk (33) of the said clutch (1), on the engine side, the said intermediate shaft (7) collaborating with the support element (16) via a bearing (20) supporting and guiding the rotation of the intermediate shaft (7) with respect to the support element (16);
an electric machine (3) comprising an external stator (8) supported by the support element (16) and a rotor (9) having a central opening through which the intermediate shaft (7) passes, the said rotor (9) being mounted to rotate as one with the said intermediate shaft (7); and
a reaction plate (10) of a clutch (2), on the gearbox side, which rotates as one with the said intermediate shaft (7).

2. Preassembled module according to claim 1, in which the intermediate shaft (7) collaborates with the support element (16) via a rolling bearing (20), the support element (16) comprising a cylindrical bore for housing the said rolling bearing (20) which is limited, on the engine side, by a radial surface against which the rolling bearing (20) can press axially, and the intermediate shaft (7) comprising, on the gearbox side, a shoulder defining a radial surface against which the rolling bearing (20) can press axially.

3. Preassembled module according to claim 1, in which the rolling bearing (20) comprises an external ring coupled axially to the support element (16) and an internal ring coupled axially to the intermediate shaft (7).

4. Preassembled module according to claim 3, in which the internal ring and the external ring are coupled axially by force-fitting and/or by immobilizing members.

5. Preassembled module according to claim 1, in which the rotor (9) is mounted to rotate as one with the intermediate shaft (7) by means of a sheet metal support hub (22), the said hub (22) comprising an axial skirt (26) for supporting the rotor (9) and an annular radial web (28) bearing the reaction plate (10) of the clutch (2) on the gearbox side.

6. Preassembled module according to claim 1, in which the intermediate shaft (7) comprises a collar (23) and in which the support hub (22) that supports the rotor (9) comprises an internal flange (25), extending radially towards the inside of the axial skirt (26), fixed to the said collar (23) of the intermediate shaft (7).

7. Preassembled module according to claim 1, comprising a clutch (2) on the gearbox side, the said clutch comprising, in addition to the reaction plate (10) that rotates as one with the intermediate shaft (7), a friction disk (11) comprising a splined hub intended to collaborate with complementary splines of an input shaft of the gearbox and a pressure plate (13), which rotates as one with the reaction plate (10) and is mounted with the ability to move axially with respect to the said reaction plate (13) between an engaged position in which the friction disk (11) is gripped between the said pressure and reaction plates (13, 10) and a disengaged position.

8. Preassembled module according to claim 1, in which the support element (16) is provided with through-orifices (35) for the passage of fixing members.

9. Preassembled module according to claim 1, in which the stator (8) is fixed to the support element (16) by shrink-fitting or force-fitting.

10. Method for mounting a transmission assembly for a motor vehicle between an engine block and a gearbox, said method comprising:
a step of mounting a clutch (1), on the engine side, on the engine block;
a step of assembling a preassembled module according to claim 1;
a step of mounting the preassembled module on the gearbox casing (17) or on the engine block (34);
a step of assembling the gearbox and the engine block (34), the gearbox and the engine block (34) being fixed to one another via the preassembled module.

11. Method of mounting according to claim 10, in which the support element (16) is provided with fixing through-orifices (35) for the passage of fixing screws and in which the preassembled module is mounted on the casing (17) of the gearbox before the gearbox and the engine block (34) are assembled, the step of mounting the preassembled module on the casing (17) of the gearbox involving the introduction of screws into a first group of fixing orifices (35) so as to fix the preassembled module to the casing (17) of the gearbox and the step of assembling the gearbox and the engine block (34) involving the introduction of screws into a second group of fixing orifices (35) in order to fix the preassembled module to the engine block (34).

12. Method of mounting according to claim 10, in which the support element (16) is provided with fixing through-orifices (35) for the passage of fixing screws and in which the preassembled module is mounted on the engine block (34) before the gearbox and the engine block (34) are assembled, the step of mounting the preassembled module on the casing (17) of the gearbox involving the introduction of screws into a first group of fixing orifices (35) so as to fix the preassembled module to the engine block (34), and the step of assembling the gearbox and the engine block (34) involving the introduction of screws into a second group of fixing orifices (35) in order to fix the preassembled module to the casing (17) of the gearbox.

13. Method of mounting according to claim 10, in which the support element (16) is provided with fixing through-orifices (35) for the passage of fixing members and in which the fixing members are studs with two threaded ends.

14. Preassembled module according to claim 2, in which the rotor (9) is mounted to rotate as one with the intermediate shaft (7) by means of a sheet metal support hub (22), said hub (22) comprising an axial skirt (26) for supporting the rotor (9) and an annular radial web (28) bearing the reaction plate (10) of the clutch (2) on the gearbox side.

15. Preassembled module according to claim 3, in which the rotor (9) is mounted to rotate as one with the intermediate shaft (7) by means of a sheet metal support hub (22), said hub (22) comprising an axial skirt (26) for supporting the rotor (9) and an annular radial web (28) bearing the reaction plate (10) of the clutch (2) on the gearbox side.

16. Preassembled module according to claim 4, in which the rotor (9) is mounted to rotate as one with the intermediate shaft (7) by means of a sheet metal support hub (22), said hub (22) comprising an axial skirt (26) for supporting the rotor (9) and an annular radial web (28) bearing the reaction plate (10) of the clutch (2) on the gearbox side.

17. Preassembled module according to claim 2, in which the intermediate shaft (7) comprises a collar (23) and in which the support hub (22) that supports the rotor (9) comprises an internal flange (25), extending radially towards the inside of the axial skirt (26), fixed to said collar (23) of the intermediate shaft (7).

18. Preassembled module according to claim 3, in which the intermediate shaft (7) comprises a collar (23) and in which the support hub (22) that supports the rotor (9) comprises an internal flange (25), extending radially towards the inside of the axial skirt (26), fixed to said collar (23) of the intermediate shaft (7).

19. Preassembled module according to claim 4, in which the intermediate shaft (7) comprises a collar (23) and in which the support hub (22) that supports the rotor (9) comprises an internal flange (25), extending radially towards the inside of the axial skirt (26), fixed to said collar (23) of the intermediate shaft (7).

20. Preassembled module according to claim 5, in which the intermediate shaft (7) comprises a collar (23) and in which the support hub (22) that supports the rotor (9) comprises an internal flange (25), extending radially towards the inside of the axial skirt (26), fixed to said collar (23) of the intermediate shaft (7).
